(19) United States
(12) Patent Application Publication
(10) Pub. No.: US 2025/0382213 A1
(43) Pub. Date: Dec. 18, 2025

(54) PROCESS FOR THE MANUFACTURE OF FRIT

(71) Applicant: SICER S.p.A., Fiorano Modenese (MO) (IT)

(72) Inventors: Giovanni PEZZI, Fiorano Modenese (MO) (IT); Palmiro BRUNETTI, Fiorano Modenese (MO) (IT); Nicolas POLIMENI, Fiorano Modenese (MO) (IT); Sergio MARCACCIOLI, Fiorano Modenese (MO) (IT); Giuliano FERRARI, Fiorano Modenese (MO) (IT); Fabio TERZI, Fiorano Modenese (MO) (IT)

(73) Assignee: SICER S.p.A., Fiorano Modenese (MO) (IT)

(21) Appl. No.: 18/877,852

(22) PCT Filed: Jul. 4, 2023
(86) PCT No.: PCT/IB2023/056935

§ 371 Date: Dec. 20, 2024

(30) Foreign Application Priority Data
Jul. 4, 2022 (IT) 102022000014149

(51) Int. Cl. C03B 19/10

(52) U.S. Cl. CPC C03B 19/1045; C03B 19/104

(57) ABSTRACT

A process for the manufacture of frit, comprises at least the following phases of: supply of a molten glassy mixture at a temperature above 1.150° C.; first cooling of the molten glassy mixture; and, subsequent to the first cooling phase, at least one second cooling phase of the molten glassy mixture to form a frit.

### TECHNICAL FIELD

The present invention relates to a process for the manufacture of frit.

In detail, this process relates to the manufacture of opaque frit, particularly of white color.

### BACKGROUND ART

Frits are loose glassy mixtures comprise substances such as alkaline and alkaline-earth silicates, borates, fluorides and feldspars typically used in the formulation of ceramic inks.

In detail, frits of defined composition and characteristics are used to obtain glazes, depending on the effects to be achieved, to which other components are generally added (clay minerals, pigments, opacifiers, oxides or inorganic compounds in general) for specific purposes.

Such mixtures are obtained by melting the raw materials and, by subsequent sudden cooling, the latter quickly passing from the liquid to the solid phase. This process, known by the term “fritting”, results in the granulation of the mixture which, crumbling as a result of the sudden cooling, takes on the typical shape from which frits take their name by analogy.

The timing and method of cooling the glassy mixture takes on special importance with respect to the chemical and physical properties of the frit.

In addition, the coloring of the frit varies depending on the raw materials used in the mixture as well as the degree of its transparency or opacity.

In this regard, raw materials of the type of cristobalite, quartz and titanium dioxide are currently used to obtain white frit.

These raw materials are highly harmful to people's health and, therefore, there are many regulatory restrictions on their use.

In fact, such raw materials result in the formation of crystalline phases within the frit which are released into the surrounding environment during the machining of ceramic manufactured articles, such as e.g. during the cutting of the latter.

Alternatively, an additional drawback of known frit manufacturing processes is that the colorations of the resulting frits may have inhomogeneities due to the cooling process, i.e., the mismanagement of cooling timing and temperatures, adversely affecting the degree of transparency and/or color of the frit itself. Currently, the glassy mixture is cooled according to different methods, which comprise, e.g., direct casting of the molten glassy mixture into refrigerated water.

Alternatively, some cooling methods involve cooling consisting in the action of jets of refrigerated water intercepting the molten mixture in combination with the casting of the latter within a refrigerated liquid.

These cooling methods are described in patent documents U.S. Pat. Nos. 3,150,947, 3,997,310, 3,323,888, 3,294,511, 3,190,737, 3,133,805 and 2,616,124.

These processes have numerous drawbacks, among which is the fact that they involve the use of a single cooling phase during which it is not possible to precisely modulate the cooling speed of the glassy mixture and, consequently, the corresponding chemical-physical and chromatic properties of the frit thus obtained.

Other processes for the manufacture of frit are known from patent documents No. DE 10 2004 041357, No. EP 0 867 526 and WO 2020/053825.

These documents describe processes in which the cooling speed of the glass cannot be controlled and, as a result, they do not allow the properties of the resulting frit to be modulated.

### DESCRIPTION OF THE INVENTION

The main aim of the present invention is to devise a process for the manufacture of frit which allows modulating the cooling speed of the glassy mixture precisely and accurately and the corresponding chemical-physical properties of the resulting frit.

Another object of the present invention is to devise a process for the manufacture of frit which allows producing non-transparent frit, preferably white in color.

A further object of the present invention is to devise a process for the manufacture of frit which avoids the use of substances harmful to people's health while ensuring the same chemical-physical properties.

Another object of the present invention is to devise a process for the manufacture of frit which can overcome the aforementioned drawbacks of the prior art within the framework of a simple, rational, easy and effective to use as well as inexpensive solution.

The aforementioned objects are achieved by this process for the manufacture of frit having the characteristics of claim 1.

### BRIEF DESCRIPTION OF THE DRAWINGS

Other characteristics and advantages of the present invention will become more apparent from the description of a preferred, but not exclusive, embodiment of a process for the manufacture of frit, illustrated by way of an indicative, yet non-limiting example, in the accompanying tables of drawings in which:

FIGS. 1-5 are schematic representations of the process according to the invention.

### EMBODIMENTS OF THE INVENTION

With particular reference to these figures, reference numeral 1 denotes a process for the manufacture of frit.

The process 1 comprises at least the following phases of:
supply 11 of a molten glassy mixture 2 at a melting temperature above 1.150° C.;
first cooling 3 of the molten glassy mixture 2.

In detail, the molten glassy mixture 2 comprises:
silica present in a concentration by weight, evaluated with respect to the total weight of the mixture, between 25% and 75%;
calcium oxide present in a concentration by weight, evaluated with respect to the total weight of the mixture, between 5% and 40%;
boric anhydride present in a concentration by weight, evaluated with respect to the total weight of the mixture, between 0% and 20%;
phosphoric anhydride present in a concentration by weight, evaluated with respect to the total weight of the mixture, between 0% and 20%.

The phase of supply 11 is carried out by means of a dispensing port 15 of a type known to the branch engineer and in fluidic communication with the melting furnace.

According to the invention, the process 1 comprises, subsequently to the first cooling phase 3, a second cooling phase 7 of the molten glassy mixture 2 to form an opaque frit 4.

Preferably, the first cooling phase 3 and the second cooling phase 7 are carried out, respectively, by using a thermal fluid at a temperature below 200° C.

In accordance with a preferred embodiment of the process according to the invention, the first cooling phase 3 is carried out by using the thermal fluid at a first temperature, and the second cooling phase 7 is carried out by using the thermal fluid at a second temperature, wherein the first temperature is lower than the second temperature.

In accordance with an alternative embodiment of the process according to the invention, the first cooling phase 3 is carried out by using the thermal fluid at a first temperature and the second cooling phase 7 is carried out by using the thermal fluid at a second temperature, wherein the first temperature is higher than the second temperature.

In detail, during the first cooling phase 3, the molten glassy mixture 2 undergoes a temperature drop comprised between 1° C. and 300° C. and, during the second cooling phase 7, the molten glassy mixture undergoes a temperature drop comprised between 20° C. and 1700° C. at which the molten glassy mixture 2 does not crystallize thus forming the frit 4.

This means that the sudden change in temperature to which the molten glassy mixture 2 is subjected prevents crystalline phases from forming by resulting in the formation of only one or more glassy phases.

In detail, this expedient allows obtaining a frit white in color.

In detail, the first cooling phase 3 is carried out by means of first cooling means 8 and the second cooling phase 7 is carried out by means of second cooling means 9.

As visible in the figures, the first cooling means 8 comprise at least one first pair of rotating cylinders 10 refrigerated by the thermal fluid and driven in rotation at a first predefined rotational speed, the molten glassy mixture 2 is cast between the first pair of rotating cylinders 10.

Advantageously, the thermal fluid comprises water.

This means that the first pair of refrigerated rotating cylinders 10 is cooled by water.

This means that the first pair of rotating cylinders 10 is refrigerated by means of the delivery of a cold water jet internally to the latter or, alternatively, directed onto the outer surface of the rotating cylinders themselves. In this latter case, water is delivered by means of nozzles 16 arranged in the proximity of the first pair of rotating cylinders 10.

Advantageously, the first predefined rotational speed is comprised between 0.05 rpm and 10 rpm.

Each cylinder of the first pair of rotating cylinders 10 is motorized and set in rotation around a respective axis of rotation A.

Going into detail, the molten glassy mixture 2 cast between the first pair of refrigerated rotating cylinders 10 defines a direction of forward movement B substantially orthogonal to the axis of rotation A.

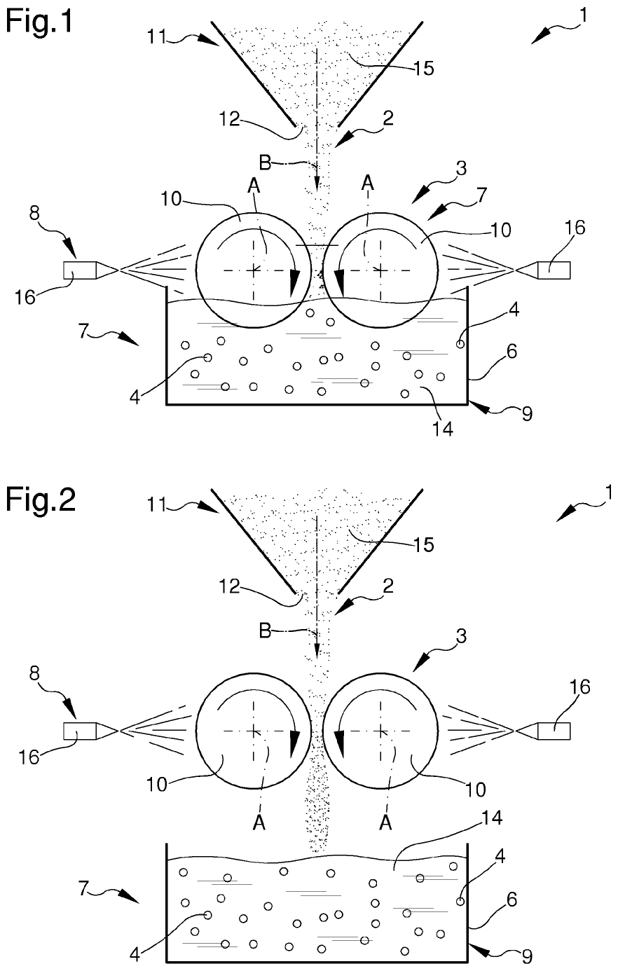

In this regard, as can be seen in FIGS. 1-4, the positioning of the molten glassy mixture 2 with respect to the first pair of refrigerated rotating cylinders 10 varies depending on the industrial requirements and the peculiar properties to be obtained, whether of the chemical-physical or colorimetric type; in this regard, it should be pointed out that this position causes a variation in the cooling times of the frit 4 by varying the optical and, consequently, colorimetric properties thereof.

As will be detailed later in this disclosure, the phase of supply 11 comprises at least one casting step 12 of the molten glassy mixture 2 in a predefined position with respect to the first pair of refrigerated rotating cylinders 10.

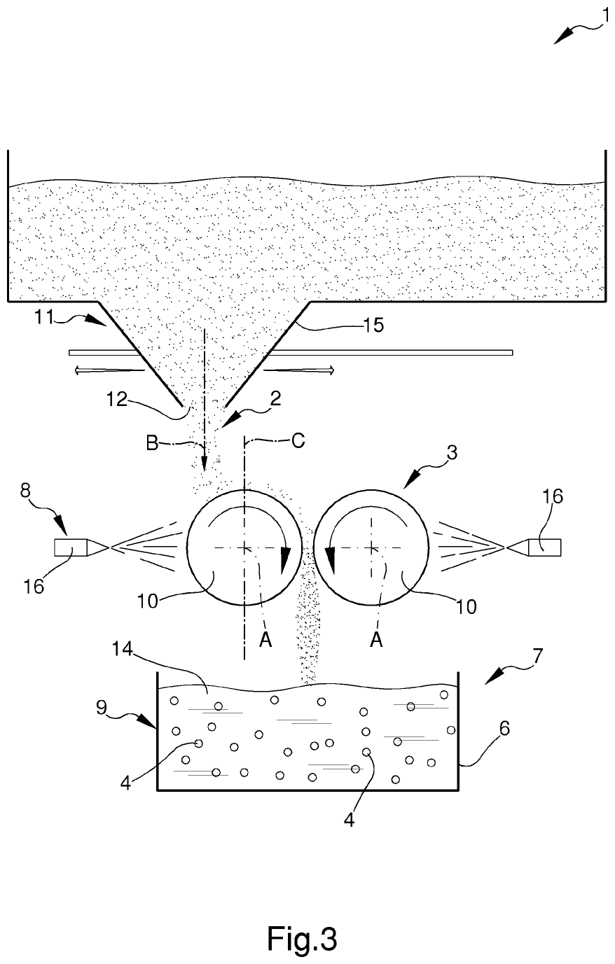

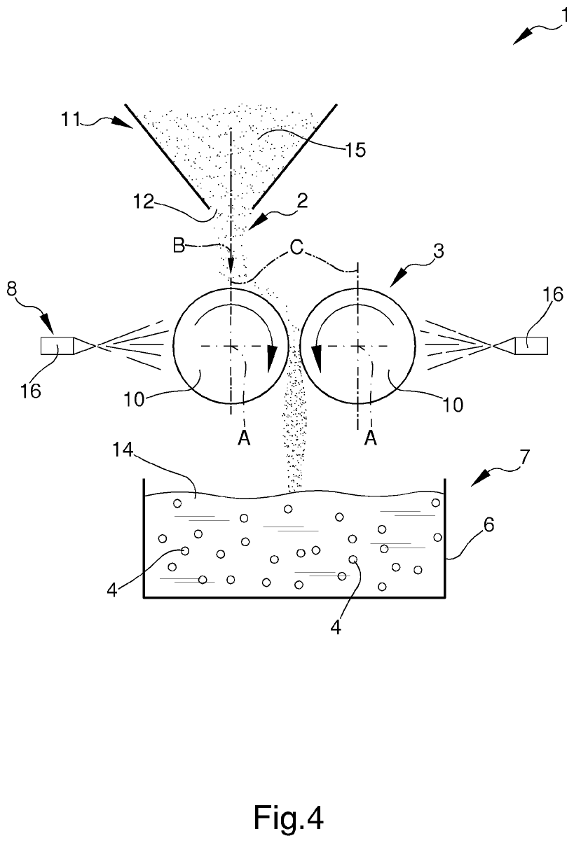

This predefined position can be identified as a first position central to the first pair of refrigerated rotating cylinders 10 (FIGS. 1, 2, and 5), a second position off-center with respect to one of the rotating cylinders of the first pair of refrigerated rotating cylinders 10 (FIG. 3) and a third position central to one of the refrigerated rotating cylinders 10 (FIG. 4).

Going into detail, the phase of supply 11 comprises at least one casting step 12 of the molten glassy mixture 2 centrally to the first pair of refrigerated rotating cylinders 10 (FIGS. 1, 2 and 5).

Alternatively, the phase of supply 11 comprises at least one casting step 12 of the molten glassy mixture 2 centrally to one of the rotating cylinders of the first pair of refrigerated rotating cylinders 10 (FIG. 4).

Additionally, alternatively, the phase of supply 11 comprises at least one casting step of the molten glassy mixture in an off-center position with respect to the center of one of the cylinders of the first pair of refrigerated rotating cylinders 10 (FIG. 3).

In detail, this off-center position is defined at the outer half-cylinder with respect to an axis of symmetry B passing through the first pair of rotating cylinders 10.

In this regard, it should be pointed out that it cannot be ruled out from the scope of the present disclosure that the process 1 may comprise a phase of varying the casting position of the molten glassy mixture 2 on the first pair of refrigerated rotating cylinders 10 (FIG. 3).

This means that the dispensing port 15 of the molten glassy mixture 2 is associated with movement means adapted to allow it to be shifted with respect to the first pair of rotating cylinders 10 during the casting 12 of the molten glassy mixture itself.

It cannot also be ruled out from the scope of this disclosure that the movement means are adapted to allow the orientation of the dispensing port 15 with respect to the first pair of rotating cylinders 10. For example, in the latter case, the movement means are adapted to allow the oscillation of the dispensing port 15.

It should be pointed out that the casting position of the molten glassy mixture 2 takes special importance because the cooling time of the glassy mixture itself and, therefore, the timing and chemical-physical characteristics of the frit 4 are closely related thereto.

In fact, an extremely slow cooling time corresponds to the formation of frit free of crystalline phases within it, resulting in the formation of a transparent frit. Conversely, a slow cooling speed corresponds to the formation of crystalline phases within the frit itself, resulting in the formation of an opaque frit.

In this regard, it is worth pointing out that the synergistic combination of a first cooling phase 3 and of a second cooling phase 7 allows modulating the cooling speed of the molten glassy mixture, making it possible to intervene in the properties of the resulting frit and, in the present case, ensure the formation of an opaque frit, preferably white in color.

It should be pointed out that this colorimetric characteristic is due to the absence of crystalline phases and to the presence of one or more glassy phases closely mixed together.

In accordance with a preferred embodiment shown in FIG. 1, the second cooling means 9 comprise a collecting tank 6 comprising a refrigerated fluid 14 at a temperature comprised between 1° C. and 100° C., wherein the first pair of rotating cylinders 10 is immersed at least partly in the refrigerated fluid 14.

This means that in accordance with the first embodiment of the process according to the invention, the first cooling phase 3 is carried out by using the first pair of rotating cylinders 10 and the second cooling phase 7 is carried out by dropping and collecting the frit 4 into the collecting tank 6. In this case, the thermal fluid consists of the refrigerated fluid 14.

In more detail, the molten glassy mixture 2 comes in contact with the outer surface of the first pair of rotating cylinders 10, thereby being subjected to the first temperature and, subsequently by dropping, comes in contact with the refrigerated fluid 14 contained in the collecting tank 6.

The synergistic combination of the first cooling phase 3 and of the second cooling phase 7 allows the formation of an opaque frit 4, free of crystalline phases.

In accordance with a second embodiment of the process according to the invention, shown in FIGS. 2, 3 and 4, the first pair of rotating cylinders 10 emerges with respect to the refrigerated fluid 14; this means that the first pair of rotating cylinders 10 is spaced from the collecting tank 6 and the molten glassy mixture 2 exiting the latter is collected by dropping into the collecting tank itself, being subjected to the second temperature.

Advantageously, the aforementioned refrigerated fluid 14 comprises: water, demineralized water, osmotized water or highly mineralized water.

Preferably, the refrigerated fluid has a conductivity comprised between 0 and 20 S/m.

In detail, each rotating cylinder is immersed in the refrigerated fluid 14 by a portion comprised between 0% and 90% of the diameter of each of the rotating cylinders of the first pair of rotating cylinders 10.

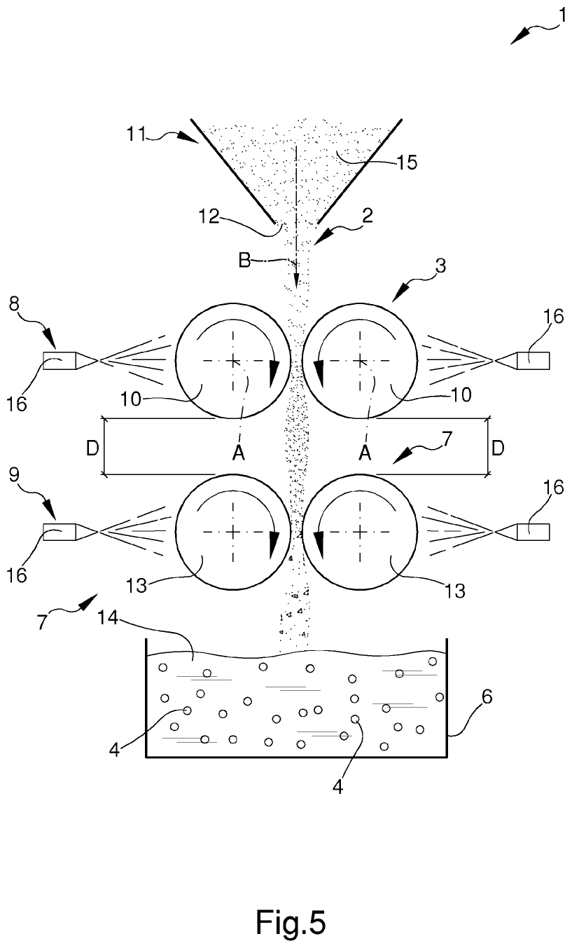

In accordance with a third embodiment of the process according to the invention, shown in FIG. 5, the second cooling means 9 comprise at least one second pair of refrigerated rotating cylinders 13 driven in rotation at a second predefined rotational speed, wherein the glassy mixture 2 exiting the first cooling means 8, i.e., the first pair of rotating cylinders 10, passes through the second cooling means 9, i.e., the second pair of refrigerated rotating cylinders 13.

Preferably, the second predefined rotational speed is comprised between 0.05 rpm and 10 rpm.

Preferably, the first cooling means and the second cooling means have a mutual distance D comprised between 5 mm and 1,000 mm.

It is specified that, in the context of this disclosure, the expression “mutual distance D” refers to the length of the straight line connecting the first cooling means 8 and the second cooling means 9.

In detail, this length is parallel to the direction of forward movement B. Additionally, the second cooling means 9 comprise the collecting tank 6.

In other words, in accordance with the aforementioned embodiment (FIG. 5), the second cooling means 9 comprise the synergistic combination of the second pair of rotating cylinders 10 and of the collecting tank 6.

Similarly to the first and second embodiments, the second pair of rotating cylinders 13 may be at least partly immersed in the refrigerated fluid 14 or, alternatively, emerge therefrom.

By the way, in the case where the second pair of refrigerated rotating cylinders 13 are immersed in the refrigerated fluid 14, the latter are immersed in the refrigerated fluid 14 by a portion comprised between 0.1% and 90% of the diameter of each of the rotating cylinders of the second pair of rotating cylinders 13.

Contact of the molten glassy mixture 2 with the first pair of rotating cylinders 10, with the second pair of rotating cylinders 13 and with the refrigerated fluid 14 contained in the collecting tank 6 results in the solidification of the molten glassy mixture 2 leading to the formation of the frit 4 characterized by the presence of one or more closely mixed glassy phases.

Advantageously, the frit 4 is opaque, preferably white in color.

In detail, the synergistic combination of the first cooling phase 3 with the second cooling phase 7 makes it possible to obtain an opaque frit that, by reflecting/dispersing light, produces a scattering phenomenon whereby the light incident thereon, appears visually white in color.

The color of the frit 4 has been measured in accordance with the CIELab measurement method.

The CIELab measurement method has been developed by the International Commission on Color (CIE) and indicates color through the three parameters of brightness (L) and the variation between red and green (a) and yellow and blue (b).

An experimental study related to the evaluation of frit color has been carried out.

This study has been carried out by making agglomerate specimens in which the frit obtained from the process according to the invention was mixed with a two-component acrylic resin generating a cylinder 3 cm in diameter and 1 cm in height.

This study was repeated using the frit 4 obtained from the process according to the invention in combination with titanium dioxide; this substance, introduced at a low concentration, generally raises the white tone of agglomerates.

For comparison, tests were carried out using cristobalite, a substance currently used to make agglomerates that are white in color but highly hazardous to human beings.

The results showed that the values of L are >80 while the values of the modulus of a and b are less than 3. The results obtained with the product described in the invention are surprisingly in line with the results for cristobalite (Table 1).

TABLE 1

| | Formulation | | Formulation | |
|---|---|---|---|---|
| | of the | | of the | |
| | invention | CHRISTOBALITE | invention | CHRISTOBALITE |
| A component | 10 | 10 | 10 | 10 |
| resin weight | | | | |
| (g) | | | | |
| B component | 6.5 | 6.5 | 6.5 | 6.5 |
| resin weight | | | | |
| (g) | | | | |
| Report | 0.65 | 0.65 | 0.65 | 0.65 |
| Titanium | | | 1.5 | 1.5 |
| dioxide | | | | |
| Total (g) | 16.5 | 16.5 | 18 | 18 |
| White | 10 | 10 | 10 | 10 |
| substance | | | | |
| weight (g) | | | | |
| Resin/frit | 1.65 | 1.65 | 1.8 | 1.8 |
| ratio | | | | |
| L | 86.9 | 76.5 | 97.9 | 97.2 |
| A | −2.3 | −1.7 | −0.9 | −0.4 |
| B | −1.3 | −2.4 | 2.15 | 2.5 |

From the point of view of chemical resistance, the specimens described above were tested according to ISO10545 standard; in particular, resistance to acid attack by 3% and 18% hydrochloric acid and potassium hydroxide was tested. The specimens were found to be unassailable according to that standard by obtaining a GLA, GHA and GA rating.

In detail, the frit 4 obtained by the process in accordance with the present invention is opaque, preferably white in color.

The special expedient of providing for the synergistic combination of the first cooling means 8 with the second cooling means 9 and a predefined casting position of the molten glassy mixture 2 allows for the avoidance of crystalline phase formation by having two closely mixed glassy phases.

Such glassy phases can form “core-shell” structures having alternating opacity or transparency.

In this regard, it should be pointed out that the frit 4 has at least one transparent phase with transmittance >50%, measured on a sample with 5 mm thickness and in the visible wavelength range.

In addition, the frit 4 has at least one opaque phase with transmittance ≤50%, measured on a sample having 5 mm thickness and in the visible wavelength range.

Each glassy phase may have a filamentous or dendriform structure.

This means that glassy phases may have very different light scattering phenomena.

Next, the process 1 comprises a collecting phase of the frit 4.

The collecting phase is carried out by means of techniques familiar to the technician in the field, such as, e.g., collection using an auger element or a bucket elevator.

Finally, optionally, the process 1 comprises at least one phase of grinding the frit 4, wherein the frit 4 is reduced to a particle size comprised between 0.5 μm and 1000 μm, preferably between 0.5 μm and 500 μm.

The above phase of grinding is carried out by using one or more grinding bodies of the type of metal rollers, by means of cryo-milling or by Jet Mill grinder.

In a second aspect, the present invention relates to the use of frit 4 in glazes, agglomerates comprising at least one polymer resin, mixes for ceramic manufactured articles, glazes, paints, plasters, engobes, plastic materials or resins.

Preferably, such agglomerates comprise at least one inert material selected from the list comprising: quartz, glass, feldspars, cristobalite, carbonates of one or more alkali earth metals, titanium dioxide or cerium dioxide.

Preferably, polymer resin is selected from the list comprising: polyurethane resins, acrylic resins or epoxy resins.

It has in practice been ascertained that the described invention achieves the intended objects.

Emphasis is placed on the fact that the special expedient of providing for two separate cooling phases allows obtaining a frit which is white in color.

In addition, the synergistic combination of the first cooling means together with the second cooling means enables the manufacture of a white-colored frit, free of crystalline phases.

The absence of crystalline phases ensures high safety for people's health, in fact, against the cutting of the manufactured articles containing the frit, the dispersion of harmful substances into the environment is avoided.

1) A process comprising at least the following phases of:
supply of a molten glassy mixture at a temperature above 1.150° C.;
first cooling of said molten glassy mixture;
subsequent to said first cooling phase, at least one second cooling phase of said molten glassy mixture to form a frit.

2) The process according to claim 1, wherein said first cooling phase and said second cooling phase are carried out respectively by using a thermal fluid at a temperature below 200° C.

3) The process according to claim 1, wherein, during said first cooling phase, said molten glassy mixture undergoes a temperature drop comprised between 1° C. and 300° C. and, during said second cooling phase, said molten glassy mixture undergoes a temperature drop comprised between 20° C. and 1700° C. at which said molten glassy material does not crystallize forming said frit.

4) The process according to claim 1, wherein said first cooling phase is carried out by means of first cooling means and said second cooling phase is carried out by means of second cooling means.

5) The process according to claim 4, wherein said first cooling means comprise at least one first pair of rotating cylinders refrigerated with said thermal fluid and driven in rotation at a first predefined rotational speed, said molten glassy mixture being cast between said first pair of rotating cylinders.

6) The process according claim 5, wherein said phase of supply comprises at least one casting step of said molten glassy mixture centrally to said first pair of refrigerated rotating cylinders.

7) The process according to claim 5, wherein said phase of supply comprises at least one casting step of said molten glassy mixture at the top of one of said cylinders of said first pair of rotating cylinders.

8) The process according to claim 5, wherein said phase of supply comprises at least one casting step of said molten glassy mixture in an off-center position with respect to the center of one of said cylinders of said first pair of rotating cylinders.

9) The process according to claim 8, wherein said off-center position is defined at the outer half-cylinder with respect to an axis of symmetry passing through said first pair of refrigerated rotating cylinders.

10) The process according to claim 5, further comprising: at least one phase of varying the casting position of said molten glassy mixture on said first pair of refrigerated rotating cylinders.

11) The process according to claim 5, wherein said second cooling means comprise at least one collecting tank comprising a refrigerated fluid at a temperature comprised between 1° C. and 100° C.

12) The process according to claim 11, wherein said second cooling means comprise at least one second pair of refrigerated rotating cylinders and driven in rotation at a second predefined rotational speed, said molten glassy mixture exiting said first cooling means passing through said second pair of rotating cylinders.

13) The process according to claim 12, wherein one of either said first pair of rotating cylinders or said second pair of rotating cylinders is immersed at least partly in said refrigerated fluid.

14) The process according to claim 12, wherein at least one of either said first predefined rotational speed or said second predefined rotational speed is comprised between 0.05 rpm and 10 rpm.

15) The process according to claim 1, wherein said molten glassy mixture comprises:
silica present in a concentration by weight, evaluated with respect to the total weight of the mixture, comprised between 40% and 65%;
calcium oxide present in a concentration by weight, evaluated with respect to the total weight of the mixture, comprised between 20% and 35%;
boric anhydride present in a concentration by weight, evaluated with respect to the total weight of the mixture, comprised between 0% and 10%; and
phosphoric anhydride present in a concentration by weight, evaluated with respect to the total weight of the mixture, comprised between 0% and 10%.

16) The process according to claim 11, wherein said refrigerated fluid comprises: water, demineralized water, osmotized water or highly mineralized water.

17) The process according to claim 1, wherein said frit is white in color.

18) The process according to claim 12, wherein one of either said first pair of rotating cylinders or said second pair of rotating cylinders is immersed in said refrigerated fluid for a portion comprised between 0% and 90% of the diameter of each of said rotating cylinders.

19) The process according to claim 1, further comprising: at least one phase of grinding said frit, said frit being reduced to a particle size comprised between 0.5 μm and 1000 μm, preferably between 0.5 μm and 500 μm.

20) Said frit obtainable by the process according to claim 1 being opaque or white in color.

21) Use of the frit according to claim 19, in glazes, agglomerates comprising at least one polymer resin, mixes for ceramic manufactured articles, glazes, paints, plasters, engobes, plastic materials or resins.
